(19) United States
(12) Patent Application Publication
(10) Pub. No.: US 2026/0074461 A1
(43) Pub. Date: Mar. 12, 2026

(54) CONNECTOR

(71) Applicant: YAZAKI CORPORATION, Tokyo (JP)

(72) Inventors: Masanori Nakamura, Kakegawa-shi (JP); Mitsuo Akiyama, Fujieda-shi (JP); Shinichi Kamura, Kakegawa-shi (JP)

(21) Appl. No.: 19/319,734

(22) Filed: Sep. 5, 2025

(30) Foreign Application Priority Data
Sep. 11, 2024 (JP) 2024-157165

(51) Int. Cl. H01R 13/52; H01R 11/12; H01R 13/02; H01R 13/512

(52) U.S. Cl. CPC H01R 13/5205; H01R 11/12; H01R 13/025; H01R 13/512; H01R 2201/26

(57) ABSTRACT

A connector for an in-vehicle component includes: a housing including a fitting portion opened in a first direction that is a fitting direction with a mating connector, and a housing portion opened in a second direction intersecting with the first direction; a first terminal including an electrode portion disposed in the fitting portion and connectable to the mating connector; a first wiring member extending in the second direction, passing through the housing portion, and electrically connected to the first terminal; and a first sealing that seals a periphery of the first wiring member at a position away from the first terminal. The housing includes a first restricting portion that restricts a position of the first wiring member in the first direction at a position between the first terminal and the first sealing in the second direction.

### BACKGROUND OF THE INVENTION

### FIELD OF THE INVENTION

An embodiment of the present invention relates to a connector.

Priority is claimed on Japanese Patent Application No. 2024-157165, filed September 11, 2024, the contents of which are incorporated herein by reference.

### DESCRIPTION OF RELATED ART

A vehicle including a connector for charging an in-vehicle battery is known.

Patent Document 1 discloses a connector including a mounting plate, an inner cylindrical portion, an outer cylindrical portion, an electric wire, and a rubber plug. In the connector described in Patent Document 1, the rubber plug seals a gap between the electric wire drawn out from the inner cylinder portion and an opening portion of the outer cylinder portion protruding to a vehicle interior side.

### Prior Art Document

### Patent Document

Patent Document 1: Japanese Unexamined Patent Application, First Publication No. 2012-243467

### SUMMARY OF THE INVENTION

In the connector as described above, a deviation of a wiring member such as an electric wire may increase. In order to absorb the deviation of the wiring member and to ensure a sealing performance, a large seal member is required. When a large sealing material is used, it is difficult to downsize the connector.

One embodiment provides a connector that can be downsized.

A connector of one embodiment is a connector for an in-vehicle component, including: a housing including a fitting portion opened in a first direction that is a fitting direction with a mating connector, and a housing portion opened in a second direction intersecting with the first direction; a first terminal including an electrode portion disposed in the fitting portion and connectable to the mating connector; a first wiring member extending in the second direction, passing through the housing portion, and electrically connected to the first terminal; and a first sealing that seals a periphery of the first wiring member at a position away from the first terminal, in which the housing includes a first restricting portion that restricts a position of the first wiring member in the first direction at a position between the first terminal and the first sealing in the second direction.

A connector of one embodiment can be downsized.

### BRIEF DESCRIPTION OF THE DRAWINGS

FIG. 1 is a cross-sectional view illustrating a connector of an embodiment.

FIG. 2 is a view of the connector of the embodiment as viewed from a -X direction.

FIG. 3 is an enlarged cross-sectional view illustrating a periphery of a housing portion illustrated in FIG. 1.

FIG. 4 is a view of the housing portion as viewed from a -Y direction.

FIG. 5 is a perspective view illustrating a state in which an auxiliary member in the embodiment is attached to a wiring member.

FIG. 6 is a perspective view illustrating a recess of a restricting portion in the embodiment.

FIG. 7 is a cross-sectional view of a periphery of the housing portion housing the wiring member to which the auxiliary member in the embodiment is attached.

### DETAILED DESCRIPTION OF THE INVENTION

Hereinafter, an embodiment will be described with reference to the drawings. In the following description, components having the same or similar functions are denoted by the same reference numerals. Redundant descriptions of these components may be omitted.

In the present application, terms are defined as follows. “Connection” is not limited to a mechanical connection, and can include an electrical connection. That is, “connection” is not limited to a case where two elements to be connected are directly connected to each other, and can include a case where two elements to be connected are connected to each other with another element interposed therebetween. “Restrict” is not limited to a case where movement of one of two members with respect to the other is restricted by constant contact between the two members. “Restrict” can include, for example, a case where two members are not in contact with each other in a state in which no positional shift occurs, but movement of one of the two members with respect to the other is restricted by contact between the two members when one of the two members tries to be positionally shifted with respect to the other. In addition, “restrict” means that movement in at least one direction is restricted.

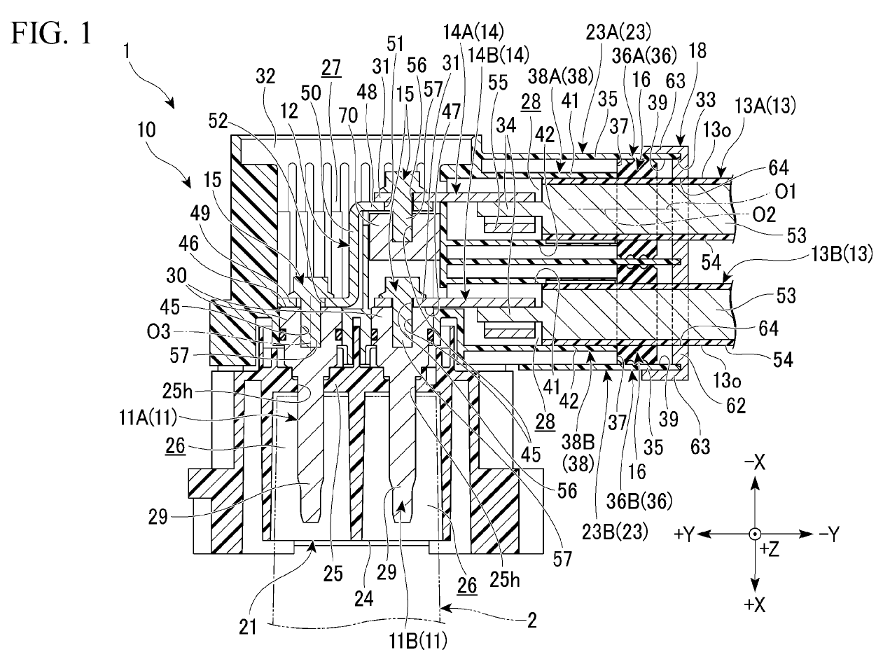

A +X direction, a -X direction, a +Y direction, a -Y direction, a +Z direction, and a -Z direction are defined as follows. The +X direction is a direction from a connector 1 toward a mating connector 2 (see FIG. 1). The -X direction is a direction opposite to the +X direction. When the +X direction and the -X direction are not distinguished from each other, they are simply referred to as “X direction”. The +Y direction and the -Y direction are directions intersecting with (for example, orthogonal to) the X direction. The +Y direction is a direction in which a wiring member 13 and a wiring member 13C described later are inserted into a housing 10. (See FIG. 1). The -Y direction is a direction opposite to the +Y direction. When the +Y direction and the -Y direction are not distinguished from each other, they are simply referred to as “Y direction”. The +Z direction and the -Z direction are directions intersecting with (for example, orthogonal to) the X direction and the Y direction. The +Z direction is a front direction in FIG. 1. The -Z direction is a direction opposite to the +Z direction. When the +Z direction and the -Z direction are not distinguished from each other, they are simply referred to as “Z direction”. The X direction is an example of “first direction”. The Y direction is an example of “second direction”.

### (Embodiment)

### <1. Configuration of connector>

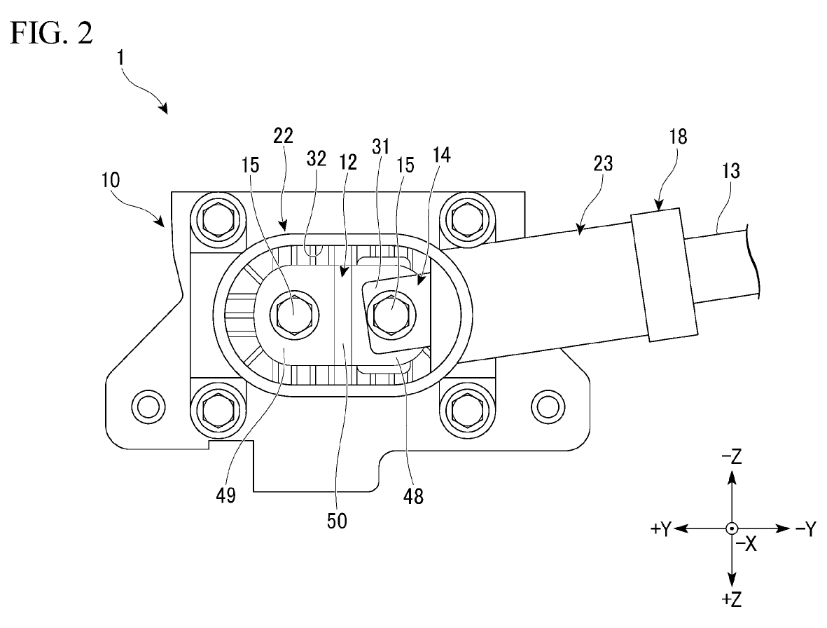

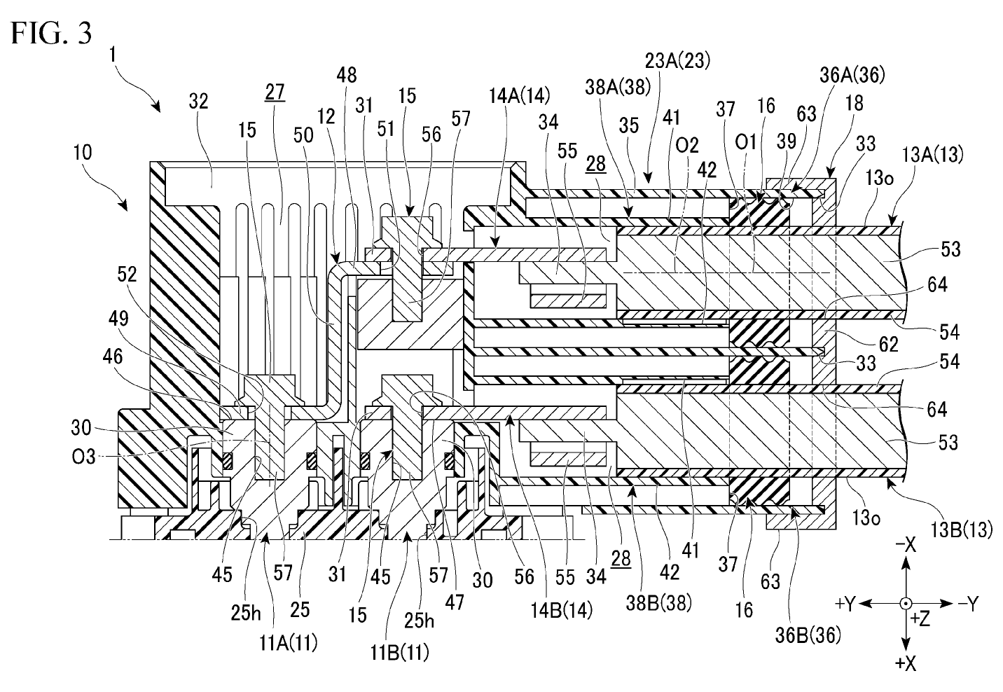

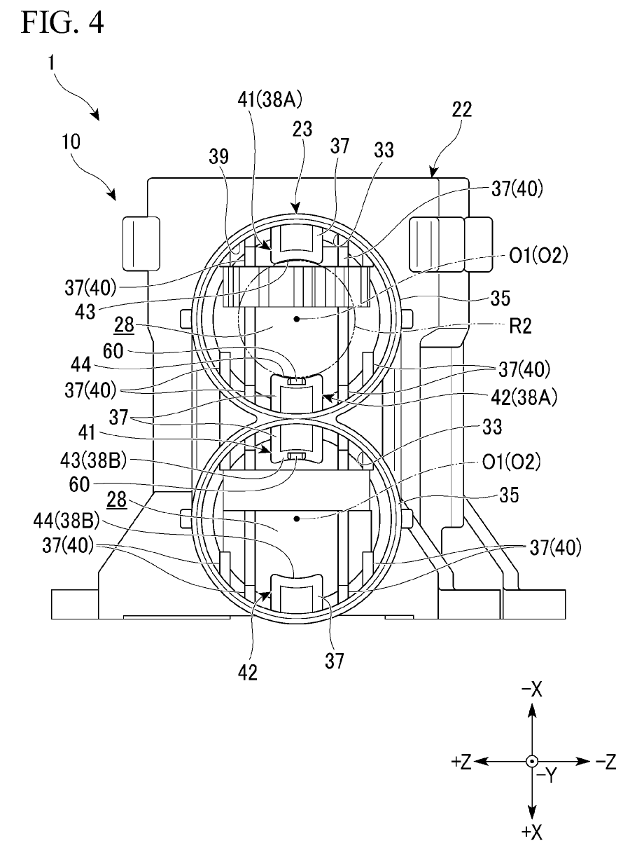

FIG. 1 is a cross-sectional view illustrating a connector of an embodiment. FIG. 2 is a view of the connector of the embodiment as viewed from a -X direction. FIG. 3 is an enlarged cross-sectional view illustrating a periphery of a housing portion illustrated in FIG. 1. FIG. 4 is a view of the housing portion as viewed from a -Y direction.

A connector 1 is provided in a vehicle including an in-vehicle battery, such as an electric vehicle (EV), a hybrid electric vehicle (HEV), or a plug-in hybrid electric vehicle (PHEV). A mating connector 2 provided in an external charging facility is attachable to and detachable from the connector 1. The connector 1 supplies power supplied from the mating connector 2 to, for example, a charging circuit for charging an in-vehicle battery.

As illustrated in FIGS. 1 to 3, the connector 1 includes, for example, a housing 10, a terminal 11, a bus bar 12, a wiring member 13, a connection terminal 14, a fastener 15, a sealing 16, and a rear holder 18.

### <1.1 Housing>

As illustrated in FIG. 1, the housing 10 covers an exposed conductive portion from the outside. The exposed conductive portion is, for example, the terminal 11 or an end portion of the wiring member 13. The housing 10 includes a fitting portion 21, a terminal block portion 22, and a housing portion 23. The housing 10 is made of an electrically insulating material such as a synthetic resin. The housing 10 is fixed to a vehicle body (not illustrated), for example.

### <1.1.1 Fitting portion>

The fitting portion 21 has a first opening 24 opened in the +X direction (first direction) that is a direction in which the fitting portion 21 is fitted to the mating connector 2. The mating connector 2 protrudes in the X direction. The fitting portion 21 is recessed in the X direction so as to correspond to the mating connector 2. The fitting portion 21 forms a connector space 26. The mating connector 2 can be inserted into and removed from the connector space 26 in the X direction through the first opening 24. In the housing 10, only the fitting portion 21 is accessible from the outside of the vehicle body.

The fitting portion 21 has a partition wall 25 in the -X direction opposite to the first opening 24. The partition wall 25 partitions the space from the terminal block portion 22. A through hole 25h penetrating the partition wall 25 in the X direction is formed in the partition wall 25. Through the through hole 25h of the partition wall 25, the terminal 11 described later is disposed over the connector space 26 and a housing space 27 of the terminal block portion 22. An electrode portion 29 of the terminal 11 is disposed in the connector space 26.

### <1.1.2 Terminal block portion>

The terminal block portion 22 forms the housing space 27. The housing space 27 houses a fastening portion 30 of the terminal 11, a fastening portion 31 of the connection terminal 14, the bus bar 12, and the fastener 15. The terminal block portion 22 has an access hole 32 opened in the -X direction such that a tool (not illustrated), the bus bar 12, the fastener 15, and the like can be inserted into the housing space 27.

### <1.1.3 Housing portion>

The housing portion 23 forms a housing space 28 that houses the wiring member 13. The housing portion 23 has a tubular shape extending in the Y direction. The housing portion 23 has a second opening 33 opened in the -Y direction. The housing space 28 houses a part in the +Y direction of the wiring member 13 described later. An end portion 34 of the wiring member 13 to which the connection terminal 14 is attached is inserted into the housing portion 23 from the second opening 33 in the +Y direction. A part of the wiring member 13 housed in the housing space 28 includes the end portion 34 to which the connection terminal 14 is attached.

As illustrated in FIGS. 3 and 4, the housing portion 23 of the present embodiment has a cylindrical outer wall 35. The outer wall 35 has a cylindrical shape formed to have a diameter equal to or larger than a maximum diameter of the wiring member 13 assumed to be used. The outer wall 35 extends in the Y direction. The outer wall 35 has a constant inner diameter in the Y direction. The housing space 28 communicates with the housing space 27 of the terminal block portion 22 in the Y direction. The connection terminal 14 attached to the end portion 34 of the wiring member 13 extends in the +Y direction from the housing space 28 and reaches the housing space 27 of the terminal block portion 22.

The housing portion 23 includes a sealing housing portion 36, a butting surface 37, and a restricting portion 38.

The sealing housing portion 36 houses the sealing 16 described later. The sealing housing portion 36 has an outer peripheral seal surface 39 having a ring shape. The outer peripheral seal surface 39 has a ring shape whose entire circumference is in contact with an outer peripheral surface 16o of the ring-shaped sealing 16. An inner diameter of the outer peripheral seal surface 39 is constant in the Y direction. The outer peripheral seal surface 39 extends in the +Y direction from the second opening 33. In the present embodiment, an inner peripheral surface of the outer wall 35 is the outer peripheral seal surface 39.

Here, the housing 10 of the present embodiment includes a first housing portion 23A and a second housing portion 23B. The first housing portion 23A and the second housing portion 23B are two housing portions 23 adjacent to each other in the X direction. The first housing portion 23A houses a first wiring member 13A as the wiring member 13. The second housing portion 23B houses a second wiring member 13B as the wiring member 13. Furthermore, the housing 10 of the present embodiment includes a first sealing housing portion 36A and a second sealing housing portion 36B which are two sealing housing portions 36 adjacent to each other in the X direction. The first sealing housing portion 36A is disposed in the first housing portion 23A. The second sealing housing portion 36B is disposed in the second housing portion 23B. Note that, in the following description, when it is not necessary to distinguish the first housing portion 23A and the second housing portion 23B from each other, they are simply referred to as a housing portion 23. Furthermore, when it is not necessary to distinguish the first sealing housing portion 36A and the second sealing housing portion 36B from each other, they are simply referred to as a sealing housing portion 36.

### <1.1.4 Butting surface>

As illustrated in FIGS. 3 and 4, the butting surface 37 butts against the sealing 16 in the Y direction. In the present embodiment, the butting surface 37 is formed in each of the first housing portion 23A and the second housing portion 23B. The butting surface 37 positions the sealing 16 in the Y direction. The butting surface 37 butts against the sealing 16 inserted in the +Y direction from the second opening 33, thereby restricting further displacement of the sealing 16 in the +Y direction. The butting surface 37 is a surface extending in the X direction and the Z direction perpendicular to the Y direction. The butting surface 37 is formed adjacent to the outer peripheral seal surface 39 in the +Y direction. The butting surface 37 of the present embodiment is formed by an end surface facing the -Y direction of a rib 40 extending in the vertical direction which is the X direction from an inner peripheral surface of the outer wall 35 and an end surface facing the -Y direction of the first restricting portion 38A.

### <1.1.5 Restricting portion>

The restricting portion 38 positions the wiring member 13 disposed inside the housing 10 in the X direction. Specifically, the restricting portion 38 positions, in the X direction, a wiring member 13 positioned between the sealing housing portion 36 and the connection terminal 14 among the wiring members 13. The housing 10 of the present embodiment includes the first restricting portion 38A and a second restricting portion 38B as two restricting portions 38. The first restricting portion 38A positions the first wiring member 13A. The second restricting portion 38B positions the second wiring member 13B. In the following description, when it is not necessary to distinguish the first restricting portion 38A and the second restricting portion 38B from each other, they are simply referred to as a restricting portion 38. Note that the restricting portion 38 may position the wiring member 13 disposed inside the housing 10 in the Z direction in addition to positioning the wiring member 13 disposed inside the housing 10 in the X direction.

The restricting portion 38 includes a first protruding portion 41 and a second protruding portion 42. That is, the first restricting portion 38A of the present embodiment includes the first protruding portion 41 and the second protruding portion 42. Similarly, the second restricting portion 38B of the present embodiment also includes the first protruding portion 41 and the second protruding portion 42. The first protruding portion 41 protrudes in the +X direction from an inner peripheral surface positioned in the most -X direction among the inner peripheral surfaces of the outer wall 35. The second protruding portion 42 protrudes in the -X direction from a position positioned in the most +X direction among the inner peripheral surfaces of the outer wall 35. The first protruding portion 41 and the second protruding portion 42 extend in the +Y direction from the position of the butting surface 37 in the Y direction.

The restricting portion 38 is disposed at a position closer to the sealing 16 than to the terminal 11. The width of the restricting portion 38 in the Y direction is larger than the width of the sealing 16 in the Y direction. The restricting portion 38 extends over the entire length of the wiring member 13 extending toward the terminal 11 side beyond the sealing 16. The amount of protrusion of the restricting portion 38 in the X direction is larger than the plate thickness of the connection terminal 14.

The first protruding portion 41 has a first curved surface 43 having an arc shape when viewed from the Y direction. The first curved surface 43 is formed to be centered on an extension line O2 obtained by extending a center line O1 of the outer peripheral seal surface 39 in the +Y direction. Similarly, the second protruding portion 42 has a second curved surface 44 having an arc shape when viewed from the Y direction. The second curved surface 44 is formed to be centered on the extension line O2. That is, the first curved surface 43 and the second curved surface 44 are formed on the same virtual circle R2 centered on the extension line O2 when viewed from the Y direction.

The diameter of the virtual circle R2 is set to be the same as a maximum diameter among the diameters of the wiring members 13 assumed to be used. For example, when such a wiring member 13 having a maximum diameter is inserted into the housing portion 23 in the +Y direction, each of the first curved surface 43 and the second curved surface 44 comes into contact with an outer peripheral surface 13o of the wiring member 13. As a result, a displacement of the wiring member 13 in the X direction is restricted. In addition, since the first curved surface 43 and the second curved surface 44 are recessed curved surfaces, a displacement of the wiring member 13 in the Z direction with respect to the restricting portion 38 is also restricted at the same time. Note that FIGS. 1 and 3 illustrate a case where the first wiring member 13A having a maximum diameter is housed in the first housing portion 23A. Similarly, FIGS. 1 and 3 illustrate a case where the second wiring member 13B having a maximum diameter is housed in the second housing portion 23B.

### <1.2 Terminal>

As illustrated in FIGS. 1 and 3, the terminal 11 includes the electrode portion 29 disposed in the fitting portion 21 and the fastening portion 30 supported by the housing 10 as described above. In the present embodiment, two terminals 11 of a first terminal 11A and a second terminal 11B are adjacent to each other in the Y direction. The first terminal 11A and the second terminal 11B have the same shape. Note that when it is not necessary to distinguish the first terminal 11A and the second terminal 11B from each other, they are simply referred to as a terminal 11.

The electrode portion 29 of the terminal 11 has a pillar shape extending in the +X direction from the partition wall 25. The terminal 11 in the present embodiment has a columnar shape. The electrode portion 29 of the terminal 11 is in contact with an electrode (not illustrated) of the mating connector 2 inserted into the fitting portion 21.

The fastening portion 30 of the terminal 11 is disposed in the housing space 27 of the terminal block portion 22. The fastening portion 30 of the terminal 11 is formed to have a larger diameter than the electrode portion 29 when viewed from the Y direction. The fastening portion 30 of the terminal 11 has a female screw portion 45 opened in the -X direction. The female screw portion 45 is formed along an axis O3 extending in the X direction. The fastening portion 30 of the terminal 11 of the present embodiment has a flat surface 46 facing the -X direction around the female screw portion 45. The flat surface 46 formed on the fastening portion 30 of the terminal 11 is a contact surface that comes into contact with the connection terminal 14 and the bus bar 12.

The flat surfaces 46 respectively formed on the fastening portion 30 of the first terminal 11A and the fastening portion 30 of the second terminal 11B are formed at the same position in the X direction. The flat surface 46 of the terminal 11 is formed, for example, at the same position in the X direction as a lower surface 47 of a connection terminal 14 (second connection terminal 14B) on a side closer to the terminal 11 in the X direction out of two connection terminals 14 adjacent to each other in the X direction.

### <1.3 Bus bar>

The bus bar 12 has at least a first end portion 48 and a second end portion 49. The bus bar 12 connects the first connection terminal 14A, which is the connection terminal 14 attached to the first wiring member 13A, to the fastening portion 31 of the first terminal 11A. The position of the first connection terminal 14A in the X direction is different from the position of the fastening portion 31 of the first terminal 11A in the X direction. The bus bar 12 of the present embodiment connects the fastening portion 30 of the first terminal 11A to the first connection terminal 14A. The fastening portion 30 of the first terminal 11A is the fastening portion 30 of the terminal 11 farther from the first wiring member 13A in the +Y direction out of the fastening portions 30 of the two terminals 11. The first connection terminal 14A is the connection terminal 14 farther from the terminal 11 in the -X direction out of the two connection terminals 14.

The bus bar 12 of the present embodiment has the first end portion 48, the second end portion 49, and an intermediate portion 50. The first end portion 48 is fastened to the first connection terminal 14A. The first end portion 48 is formed in a flat plate shape with the X direction as a thickness direction. The first end portion 48 has a through hole 51 through which a male screw portion 57 of the fastener 15 can be inserted in the X direction. Similarly to the first end portion 48, the second end portion 49 is formed in a flat plate shape with the X direction as a thickness direction. The second end portion 49 has a through hole 52 through which the male screw portion 57 of the fastener 15 can be inserted in the X direction.

The intermediate portion 50 connects the first end portion 48 to the second end portion 49. The intermediate portion 50 extends in the X direction. The first end portion 48 extends in the +Y direction from an end portion of the intermediate portion 50 in the +X direction. The second end portion 49 extends in the -Y direction from an end portion of the intermediate portion 50 in the -X direction. That is, the bus bar 12 has a crank shape when viewed from the Z direction. The intermediate portion 50 of the present embodiment is formed integrally with the first end portion 48 and the second end portion 49. The bus bar 12 having the first end portion 48, the second end portion 49, and the intermediate portion 50 can be formed, for example, by bending both end portions of one band-shaped metal plate.

### <1.4 Wiring member>

The wiring member 13 supplies power supplied via the mating connector 2 to a charging circuit (not illustrated) of an in-vehicle battery. The wiring member 13 includes a core wire portion 53 and an insulating coating portion 54. The core wire portion 53 is made of a conductive metal such as conductive copper or aluminum alloy. The insulating coating portion 54 forms an electrical insulating layer coating an outer periphery of the core wire portion 53. Examples of the insulating coating portion 54 include a synthetic resin such as polyvinyl chloride. At an end portion of the wiring member 13, the core wire portion 53 is exposed without being coated with the insulating coating portion 54. Here, the diameter of the wiring member 13 in the present embodiment is a diameter including the insulating coating portion 54. Note that examples of the wiring member 13 include an electric wire having an insulating coating and a bus bar having an insulating coating. The wiring member 13 may be a shield wire. As described above, the connector 1 of the present embodiment includes the first wiring member 13A and the second wiring member 13B as the two wiring members 13.

### <1.5 Connection terminal>

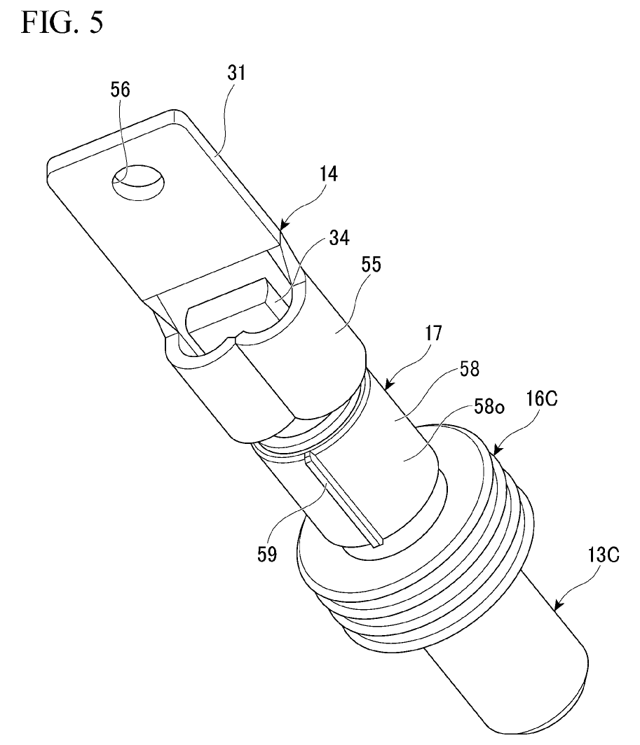

As illustrated in FIG. 5, the connection terminal 14 is attached to the end portion 34 of the wiring member 13. The connection terminal 14 extends in the +Y direction from the end portion 34. The connection terminal 14 of the present embodiment is a so-called ring terminal. The connection terminal 14 includes a crimping portion 55 and the fastening portion 31. The crimping portion 55 is fixed to the end portion 34 of the wiring member 13 in the +Y direction. The fastening portion 31 is formed in a flat plate shape extending in the +Y direction from the crimping portion 55. The fastening portion 31 has a through hole 56 penetrating the fastening portion 31 in the X direction. In the present embodiment, the connection terminal 14 is fixed to the end portion 34 of the wiring member 13 in a posture in which a thickness direction of the fastening portion 31 of the connection terminal 14 is the X direction.

The connector 1 of the present embodiment includes the first connection terminal 14A and the second connection terminal 14B as the two connection terminals 14. The fastening portion 31 of the first connection terminal 14A is fastened to the first end portion 48 of the bus bar 12 by the fastener 15 in an overlapping manner in the X direction. The fastening portion 31 of the second connection terminal 14B is fastened to the fastening portion 30 of the second terminal 11B by the fastener 15 in an overlapping manner in the X direction.

### <1.6 Fastener>

The fastener 15 has the fastening portion 30 of the terminal 11 and the male screw portion 57 to be screwed into the female screw portion 45 formed on a fastening table 70. Examples of the fastener 15 include a bolt and a screw. The fasteners 15 of the present embodiment are used for fastening the bus bar 12 to the terminal 11, fastening the bus bar 12 to the connection terminal 14, and fastening the connection terminal 14 to the terminal 11, respectively. Each of the plurality of fasteners 15 is screwed into the female screw portion 45 in the +X direction. Note that the first end portion 48 of the bus bar 12 and the first connection terminal 14A are fastened to each other by the fastener 15 in an overlapping manner in the X direction using the fastening table 70 having the female screw portion 45 opened in the -X direction.

### <1.7 Sealing>

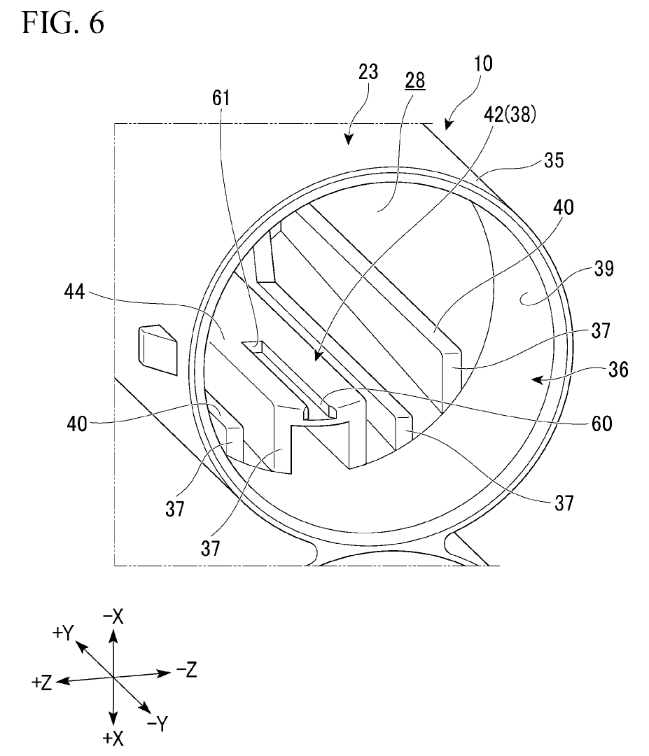

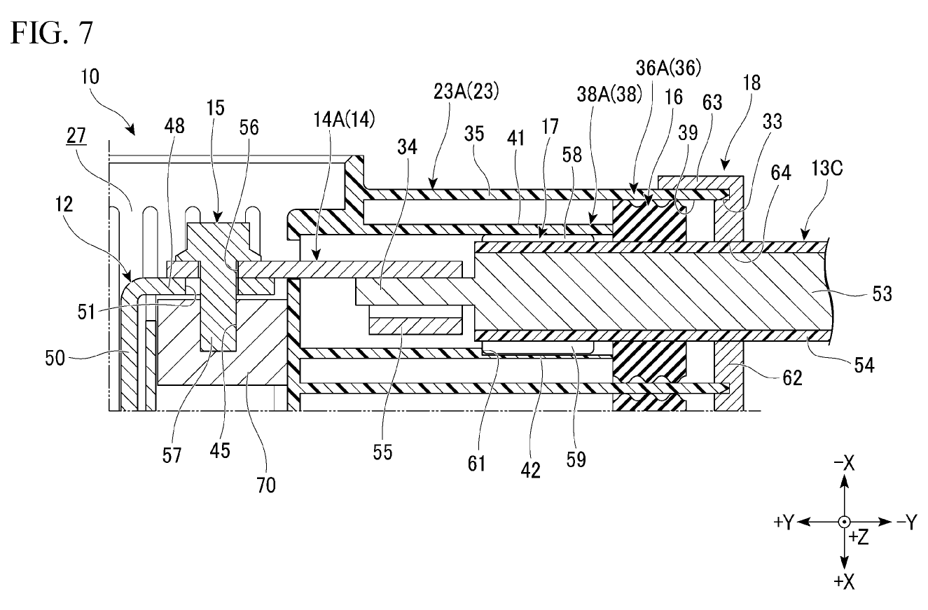

The sealing 16 seals a gap between the wiring member 13 and the housing 10. The sealing 16 is formed in a ring shape and surrounds the entire circumference of the wiring member 13. The sealing 16 is disposed between the wiring member 13 and the housing 10 in a compressively deformed state. The dimension of the sealing 16 in the radial direction is constant over the entire circumferential region of the sealing 16. In addition, the amount of compressive deformation of the sealing 16 in the radial direction is preferably constant in the entire circumferential region of the sealing 16 in order to ensure sealing performance in the entire circumference. The sealing 16 of the present embodiment is disposed for the purpose of waterproofing. Examples of a material of the sealing 16 include a synthetic rubber. The sealing 16 has an inner diameter corresponding to the outer diameter of the wiring member 13 to which the sealing 16 is to be attached. That is, when the wiring member 13 is changed to a wiring member 13C having a smaller outer diameter (see FIGS. 6 and 7), a different sealing 16C having an inner diameter corresponding to the outer diameter of the wiring member 13C is used. Note that the shape of the sealing 16, 16C may be any shape as long as it can seal a gap between the outer peripheral surface 13o of the wiring member 13 and the outer peripheral seal surface 39 of the sealing housing portion 36 in a state of being compressively deformed in a radial direction centered on the center line O1.

The connector 1 of the present embodiment has a first sealing 16A and a second sealing 16B as the two sealings 16. The first sealing 16A surrounds the first wiring member 13A. The second sealing 16B surrounds the second wiring member 13B.

### <1.8 Auxiliary member>

FIG. 5 is a perspective view illustrating a state in which an auxiliary member in the embodiment is attached to a wiring member. FIG. 6 is a perspective view illustrating a recess of a restricting portion in the embodiment. FIG. 7 is a cross-sectional view of a periphery of a housing portion housing the wiring member to which the auxiliary member in the embodiment is attached.

As illustrated in FIGS. 5 and 7, an auxiliary member 17 makes it possible for the restricting portion 38 to restrict the position in the X direction of the wiring member 13C having an outer diameter smaller than that of the wiring member 13 (hereinafter, simply referred to as the wiring member 13C), the wiring member 13 having a maximum diameter to be assumed to be used (hereinafter, simply referred to as a maximum diameter). The auxiliary member 17 of the present embodiment surrounds a periphery of the wiring member 13C. The auxiliary member 17 corrects the outer diameter of the wiring member 13C. The auxiliary member 17 of the present embodiment is fixed to the wiring member 13C. Specifically, the auxiliary member 17 is not displaced in the X direction, the Y direction, or the Z direction with respect to the wiring member 13C. Note that the wiring member 13C can be used as at least one of the first wiring member 13A and the second wiring member 13B.

The auxiliary member 17 includes a sleeve portion 58 and a protrusion 59. The sleeve portion 58 has a cylindrical shape. The sleeve portion 58 is fixed to the wiring member 13C by, for example, causing a restricting member (not illustrated) to pass through an inside of the sleeve portion 58. The outer diameter of the sleeve portion 58, that is, the diameter of an outer peripheral surface 58o is, for example, the same as a maximum diameter when the sleeve portion 58 is fixed to the wiring member 13C. For example, when the sleeve portion 58 is fixed to the wiring member 13C by crimping, the inner diameter of the sleeve portion 58, that is, the diameter of an inner peripheral surface thereof is slightly smaller than the diameter of an outer peripheral surface of the wiring member 13C to which the auxiliary member 17 is to be attached. The auxiliary member 17 has an inner diameter corresponding to the outer diameter of the wiring member 13C to which the auxiliary member 17 is to be attached.

The protrusion 59 protrudes from the outer peripheral surface 58o of the sleeve portion 58. The protrusion 59 extends in a longitudinal direction of the wiring member 13C. In the present embodiment, the length of the protrusion 59 in the longitudinal direction of the wiring member 13C is the same as the length of the sleeve portion 58 in the longitudinal direction of the wiring member 13C. The protrusion 59 is formed at a position in the most -X direction or a position in the most +X direction in the circumferential direction of the wiring member 13C when the wiring member 13C is housed in the housing portion 23.

As illustrated in FIG. 6, the above-described restricting portion 38 has a recess 60. The protrusion 59 of the auxiliary member 17 is disposed in the recess 60. The recess 60 can guide the protrusion 59 in the Y direction. The recess 60 of the present embodiment allows for positioning of the protrusion 59 in the circumferential direction of the wiring member 13C. The recess 60 of the present embodiment is opened to a side close to the extension line O2 in the X direction. The recess 60 is further opened in the -Y direction. Due to the opening of the recess 60 in the -Y direction, the protrusion 59 can be slidably inserted into the recess 60 in the +Y direction.

The recess 60 further has a stopper surface 61 for positioning the protrusion 59 in the +Y direction. The stopper surface 61 is positioned in the most +Y direction in the recess 60. As illustrated in FIG. 4, the recess 60 of the present embodiment is formed in each of the second protruding portion 42 of the first housing portion 23A and the first protruding portion 41 of the second housing portion 23B. In other words, the recess 60 is formed in each of a first protruding portion 41 and a second protruding portion 42 that are disposed close to each other in the X direction as viewed in the -Y direction among the first protruding portions 41 and the second protruding portions 42.

### <1.9 Rear holder>

As illustrated in FIG. 3, the rear holder 18 is attached to an end portion of the housing portion 23 in the -Y direction. The rear holder 18 closes the second opening 33. The rear holder 18 positions the wiring member 13 in the X direction. The rear holder 18 of the present embodiment includes a shift preventing portion 62 extending in the X direction and an attachment portion 63 extending in the +Y direction from a peripheral edge portion of the shift preventing portion 62. The attachment portion 63 is detachably attached to the housing 10. The shift preventing portion 62 has an electric wire insertion hole 64 concentric with the outer peripheral seal surface 39. The wiring member 13 can be inserted into the electric wire insertion hole 64 in the Y direction. An entire inner peripheral surface of the electric wire insertion hole 64 is in contact with the outer peripheral surface 13o of the wiring member 13. The electric wire insertion hole 64 is formed to have the same inner diameter as the outer diameter of the wiring member 13. By such a contact of the inner peripheral surface of the electric wire insertion hole 64 with the outer peripheral surface 13o of the wiring member 13, displacement of the wiring member 13 in the X direction and the Z direction is restricted. Note that, when the above-described wiring member 13C is used, the rear holder 18 having the electric wire insertion hole 64 corresponding to the diameter of the wiring member 13C is used.

### <2. Advantages>

As a configuration of Comparative Example, a case of increasing in deviation of a wiring member in a connector will be considered. In this case, a large sealing is required in order to absorb the deviation of the wiring member and to ensure sealing performance of the sealing. When a large sealing is used, it is difficult to downsize the connector.

On the other hand, the connector 1 of the present embodiment includes the housing 10, the first terminal 11A, the first wiring member 13A, and the first sealing 16A. The housing 10 includes the fitting portion 21, the housing portion 23, and the first restricting portion 38A. The fitting portion 21 is opened in the X direction which is a fitting direction with the mating connector 2. The housing portion 23 is opened in the Y direction intersecting with the X direction. The first terminal 11A includes the electrode portion 29. The electrode portion 29 is disposed in the fitting portion 21. The first terminal 11A is connectable to the mating connector 2. The first wiring member 13A extends in the Y direction. The first wiring member 13A passes through the housing portion 23. The first wiring member 13A is electrically connected to the first terminal 11A. The first sealing 16A seals a periphery of the first wiring member 13A at a position away from the first terminal 11A. The first restricting portion 38A restricts the position of the first wiring member 13A in the X direction at a position between the first terminal 11A and the first sealing 16A in the Y direction.

According to such a configuration, since it is possible to suppress an increase in deviation of the first wiring member 13A in the X direction, a large sealing for absorbing the deviation of the first wiring member 13A is unnecessary. Therefore, the connector 1 can be downsized.

In the present embodiment, the first restricting portion 38A is disposed by a part of the housing 10.

According to such a configuration, the number of components can be reduced.

In the present embodiment, the first restricting portion 38A includes the first protruding portion 41 and the second protruding portion 42 protruding from a part of an inner surface of the housing portion 23 toward the first wiring member 13A.

According to such a configuration, it is possible to efficiently suppress an increase in deviation of the first wiring member 13A in the X direction without complicating the shape of the first restricting portion 38A.

In the present embodiment, the first protruding portion 41 and the second protruding portion 42 extend in the Y direction.

According to such a configuration, the first protruding portion 41 and the second protruding portion 42 can be brought into contact with the first wiring member 13A long in the Y direction. Therefore, it is possible to further suppress the deviation of the first wiring member 13A in the X direction.

In the present embodiment, the second terminal 11B, the second wiring member 13B, and the second sealing 16B are further included. The housing 10 further includes the second restricting portion 38B. The second terminal 11B includes the electrode portion 29. The electrode portion 29 is disposed in the fitting portion 21. The second terminal 11B is connectable to the mating connector 2. The second wiring member 13B extends in the Y direction. The second wiring member 13B passes through the housing portion 23. The second wiring member 13B is electrically connected to the second terminal 11B. The second sealing 16B seals a periphery of the second wiring member 13B at a position away from the second terminal 11B. The second restricting portion 38B restricts the position of the second wiring member 13B in the X direction at a position between the second terminal 11B and the second sealing 16B in the Y direction.

According to such a configuration, since it is possible to suppress an increase in deviation of the second wiring member 13B in the X direction, a large sealing for absorbing the deviation of the second wiring member 13B is unnecessary. Therefore, the connector 1 can be downsized.

The connector 1 of the present embodiment further includes the auxiliary member 17 disposed between the wiring member 13C and the restricting portion 38.

With such a configuration, the position in the X direction of the wiring member 13C having an outer diameter smaller than the outer diameter of the first wiring member 13A and the outer diameter of the second wiring member 13B can be restricted by the restricting portion 38 without changing the dimensions of the restricting portion 38.

The auxiliary member 17 of the present embodiment further includes the protrusion 59 protruding from an outer peripheral surface thereof. The restricting portion 38 further includes the recess 60 in which the protrusion 59 is disposed. The recess 60 extends in the Y direction. The recess 60 can guide the protrusion 59 in the Y direction.

According to such a configuration, the recess 60 guides the protrusion 59 in the Y direction, whereby the wiring member 13C can be smoothly housed in the housing portion 23 together with the auxiliary member 17.

### <3. Other embodiments>

Some examples of the embodiment have been described above. However, the embodiment is not limited to the examples described above.

In the above embodiment, the case where the connector 1 is used as a charging inlet for charging an in-vehicle battery has been exemplified. However, the connector 1 is applicable to a connector that connects various electric devices in a vehicle.

In the above embodiment, the case where the X direction is the vertical direction, and the Y direction and the Z direction are the horizontal directions has been described. However, the X direction, the Y direction, and the Z direction are not limited to the above directions.

In the above embodiment, the left terminal 11 in FIG. 1 is the first terminal 11A, and the right terminal 11 is the second terminal 11B. However, the position of the first terminal 11A and the position of the second terminal 11B are not limited to the positions in FIG. 1. Similarly, in the above embodiment, the housing portion 23 positioned in the -X direction is the first housing portion 23A, and the housing portion 23 positioned in the +X direction is the second housing portion 23B. However, the position of the first housing portion 23A is not limited to the -X direction, and the position of the second housing portion 23B is not limited to the +X direction. Similarly, the positions of the first wiring member 13A, the first sealing 16A, and the first restricting portion 38A are not limited to the -X direction. The positions of the second wiring member 13B, the second sealing 16B, and the second restricting portion 38B are not limited to the +X direction.

In the above embodiment, the case where the pair of terminals 11, the pair of wiring members 13, the pair of sealings 16, and the pair of restricting portions 38 are included has been described. However, each of the number of the terminals 11, the number of the wiring members 13, the number of the sealings 16, and the number of the restricting portions 38 may be one or three or more.

In the above embodiment, the case where the sealing 16 is disposed between the wiring member 13 and the housing 10 has been described. However, the sealing may also be disposed between the wiring member 13 and the rear holder 18.

In the above embodiment, the case where the auxiliary member 17 surrounds a periphery of the wiring member 13C has been exemplified. However, the auxiliary member 17 does not have to have a shape surrounding the periphery of the wiring member 13C as long as it is disposed between the wiring member 13C and the restricting portion 38.

While the embodiments of the present disclosure have been described and illustrated above, it should be understood that these are exemplary of the present disclosure and are not to be considered as limiting. The above-described embodiments can be implemented in various other forms, and various additions, omissions, substitutions, and modifications can be made without departing from the gist of the present disclosure.

### Industrial Applicability

The connector of the present disclosure can be downsized.

### Reference Signs List

1 Connector

2 Mating connector

10 Housing

11 Terminal

11A First terminal

11B Second terminal

12 Bus bar

13, 13C Wiring member

13A First wiring member

13B Second wiring member

13o Outer peripheral surface

14 Connection terminal

14A First connection terminal

14B Second connection terminal

15 Fastener

16, 16C Sealing

16A First sealing

16B Second sealing

16o Outer peripheral surface

17 Auxiliary member

18 Rear holder

21 Fitting portion

22 Terminal block portion

23 Housing portion

24 First opening

25 Partition wall

25h Through hole

26 Connector space

27 Housing space

28 Housing space

29 Electrode portion

30 Fastening portion

31 Fastening portion

32 Access hole

33 Second opening

34 End portion

35 Outer wall

36 Sealing housing portion

36A First sealing housing portion

36B Second sealing housing portion

37 Butting surface

38 Restricting portion

38A First restricting portion

38B Second restricting portion

39 Outer peripheral seal surface

40 Rib

41 First protruding portion

42 Second protruding portion

43 First curved surface

44 Second curved surface

45 Female screw portion

46 Flat surface

47 Lower surface

48 First end portion

49 Second end portion

50 Intermediate portion

51, 52 Through hole

53 Core wire portion

54 Insulating coating portion

55 Crimping portion

56 Through hole

57 Male screw portion

58 Sleeve portion

58o Outer peripheral surface

59 Protrusion

60 Recess

61 Stopper surface

62 Shift preventing portion

63 Attachment portion

64 Electric wire insertion hole

70 Fastening table

What is claimed is:

1. A connector for an in-vehicle component, comprising:
a housing including a fitting portion opened in a first direction that is a fitting direction with a mating connector, and a housing portion opened in a second direction intersecting with the first direction;
a first terminal including an electrode portion disposed in the fitting portion and connectable to the mating connector;
a first wiring member extending in the second direction, passing through the housing portion, and electrically connected to the first terminal; and
a first sealing that seals a periphery of the first wiring member at a position away from the first terminal,
wherein the housing includes a first restricting portion that restricts a position of the first wiring member in the first direction at a position between the first terminal and the first sealing in the second direction.

2. The connector according to claim 1, wherein
the first restricting portion is disposed by a part of the housing.

3. The connector according to claim 1, wherein
the first restricting portion is a protruding portion protruding from a part of an inner surface of the housing portion toward the first wiring member.

4. The connector according to claim 3, wherein
the protruding portion extends in the second direction.

5. The connector according to claim 1, further comprising:
a second terminal including an electrode portion disposed in the fitting portion and connectable to the mating connector;
a second wiring member extending in the second direction, passing through the housing portion, and electrically connected to the second terminal; and
a second sealing that seals a periphery of the second wiring member at a position away from the second terminal,
wherein the first wiring member and the second wiring member are adjacent to each other in the first direction, and
the housing further includes a second restricting portion that restricts a position of the second wiring member in the first direction at a position between the second terminal and the second sealing in the second direction.

6. The connector according to claim 1, further comprising
an auxiliary member disposed between the first wiring member and the first restricting portion.

7. The connector according to claim 6, wherein
the auxiliary member further includes a protrusion protruding from an outer surface of the auxiliary member,
the first restricting portion further includes a recess in which the protrusion is disposed, and
the recess extends in the second direction and is capable of guiding the protrusion in the second direction.
